(19) United States
(12) Patent Application Publication
(10) Pub. No.: US 2025/0155913 A1
(43) Pub. Date: May 15, 2025

(54) BANDGAP CIRCUIT

(71) Applicant: STMicroelectronics International N.V., Geneva (CH)

(72) Inventors: Thierry MASSON, Varces (FR); Anthony QUELEN, Grenoble (FR)

(73) Assignee: STMicroelectronics International N.V., Geneva (CH)

(21) Appl. No.: 18/943,243

(22) Filed: Nov. 11, 2024

(30) Foreign Application Priority Data
Nov. 15, 2023 (FR) 2312506

(51) Int. Cl. G05F 3/26

(52) U.S. Cl. CPC G05F 3/267

(57) ABSTRACT

A bandgap circuit includes: a first resistor receiving a voltage proportional to the temperature; a second resistor receiving a voltage complementary to absolute temperature; and a third resistor where the sum of the currents in the first and second resistors flows. Each of the second and third resistors comprises a fixed resistance part and N controllable resistance parts, with N greater than or equal to 2. Each controllable resistance part of the second resistor is associated with a corresponding controllable resistance part of the third resistor. A control circuit supplies, for each controllable resistance part, the same control signal to this controllable resistance part and its associated controllable resistance part.

### PRIORITY CLAIM

This application claims the priority benefit of French Application for U.S. Pat. No. 2,312,506 filed on Nov. 15, 2023, the content of which is hereby incorporated by reference in its entirety to the maximum extent allowable by law.

### TECHNICAL FIELD

The present disclosure generally concerns electronic circuits and, more particularly, bandgap circuits configured to deliver a temperature-stable voltage.

### BACKGROUND

Many known electronic devices comprise a bandgap circuit configured to generate a temperature-stable voltage.

Known bandgap circuits are configured to generate a first voltage equal or proportional to a difference between a base-emitter voltage of a first bipolar transistor and a base-emitter voltage of a second bipolar transistor n times larger than the first bipolar transistor. This first voltage is then proportional to absolute temperature (PTAT). These known circuits are further configured to generate a second voltage equal or proportional to the base-emitter voltage of a bipolar transistor, which may or not be one of the first and second bipolar transistors. This second voltage then is of complementary to absolute temperature (CTAT) type. A third voltage is then generated from the first and second voltages and these known circuits are sized so that the third voltage has a value independent from temperature.

However, known bandgap circuits have various disadvantages.

There is a need to overcome all or part of the disadvantages of known bandgap circuits of the above-described type.

### SUMMARY

An embodiment provides a bandgap circuit comprising: a first resistor configured to receive a voltage proportional to absolute temperature across its terminals; a second resistor configured to receive a voltage complementary to absolute temperature across its terminals; a third resistor having a current through that is equal to a sum of a current through the first resistor and a current through the second resistor; and a control circuit. Each of the second and third resistors comprises a fixed part and N controllable parts, where N is an integer number greater than or equal to 2. Each controllable part is equal to a product of a set value of said controllable part and an integer determined by a control signal of said controllable part. Each of the N controllable parts of the second resistor is associated with a corresponding controllable part of the third resistor. The control circuit is configured to supply, for each controllable part, a same control signal to the controllable part and to the controllable part associated therewith. At least one controllable part has a set value different from that of the controllable part associated therewith.

According to an embodiment: a pair of a controllable part of the third resistor and the associated controllable part of the second resistor satisfies one of the following relationships: the set value of the controllable part of the third resistor is equal to Gain times the set value of the associated controllable part of the second resistor; the set value of the controllable part of the second resistor is null; and the set value of the controllable part of the third resistor is equal to Gain*Vbe(Tr)/EG times the set value of the associated controllable part of the second resistor, with Gain equal to the ratio of the resistance value of the fixed part of the third resistor by the resistance value of the fixed part of the second resistor, Vbe(Tr) the value of the voltage complementary to absolute temperature taken at a temperature Tr, Tr the reference temperature for example equal to 300° K, and EG a constant equal to 1.181 V.

According to an embodiment: another pair of a controllable part of the third resistor and of the associated controllable part of the second resistor verifies another of said relationships.

According to an embodiment: N is greater than or equal to 3; and yet another pair of a controllable part of the third resistor and the associated controllable part of the second resistor verifies yet another of said relationships.

According to an embodiment, the fixed parts of the second and third resistors have the same resistance value.

According to an embodiment, a resistance value of the fixed part of the second resistor is equal to (EG−Vbe(Tr))/(Utr*ln(n)) times a resistance value of the first resistor, where: EG is a constant equal to 1.181 V; Vbe(Tr) is the value of the voltage complementary to absolute temperature taken at a reference temperature Tr, for example equal to 300° K; Utr is equal to (k*Tr)/q, with k the Boltzmann constant and q the elementary electric charge; and n is a size ratio between two bipolar transistors configured so that a difference between base-emitter voltages of these two transistors determines and is equal to the voltage proportional to absolute temperature.

According to an embodiment: the bandgap circuit comprises two bipolar transistors of a first type among NPN and PNP having their bases connected to each other; a first of the two bipolar transistors has its emitter connected to a node for applying a reference potential, and its base and collector coupled, preferably connected, to each other; a second of the two bipolar transistors is n times larger than the first of the two bipolar transistors and has its emitter coupled with the node for applying the reference potential via the first resistor; the bandgap circuit comprises a third bipolar transistor of the first type having its base and collector coupled with each other by a buffer circuit; the emitter of the third bipolar transistor is connected to the node for applying the reference potential; and the base of the third bipolar transistor is coupled with the node for applying the reference potential via the second resistor.

According to an embodiment: the circuit comprises a first current mirror configured to supply a copy of the current flowing through the first resistor to a current summing node, and to bias the first of said two bipolar transistors; the bandgap circuit comprises a second current mirror configured to provide a copy of the current flowing through the second resistor at the current summation node; and the third resistor couples the current summation node with the node for applying the reference potential.

According to an embodiment, an additional buffer circuit is connected to the current summation node, and is configured to provide an output voltage equal to the voltage across the third resistor.

According to an embodiment: the collectors of the two bipolar transistors are coupled with a node for applying a supply potential via the first current mirror; and the buffer circuit coupling the base and the collector of the third bipolar transistor with each other, couples the base of the third transistor with the second current mirror, the second current mirror coupling this buffer circuit with the node for applying the supply potential.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows an example of a bandgap circuit;

FIG. 2 shows, in further detail, an example of a bandgap circuit of the type of that is shown in FIG. 1;

FIG. 3 schematically shows an example of calibration, or setting, of the circuits of FIGS. 1 and 2; and

FIG. 4 schematically shows an example of embodiment of a calibration or setting of a bandgap circuit of the type of those of FIGS. 1 and 2.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

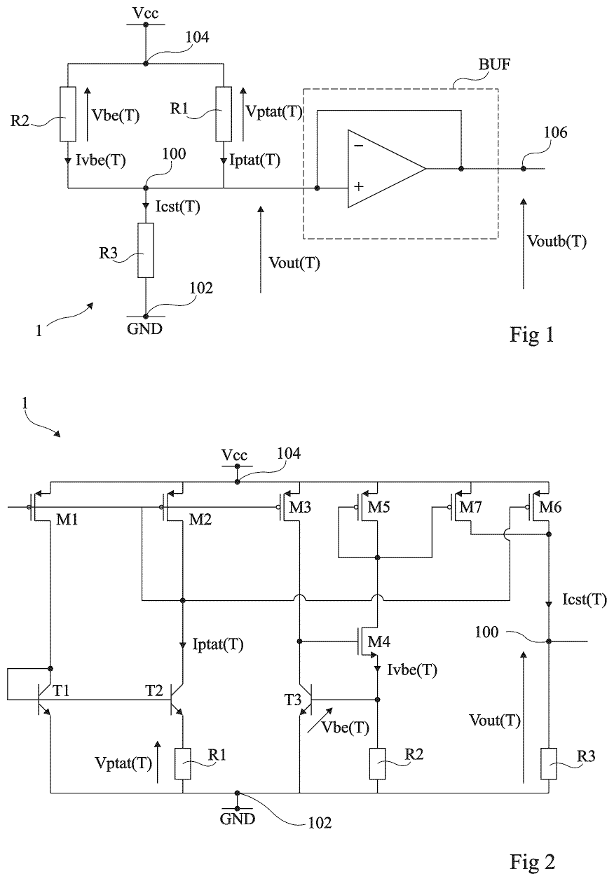

FIG. 1 schematically shows an example of a bandgap circuit 1. More particularly, FIG. 1 illustrates the principle of a bandgap circuit configured to deliver a temperature-stable voltage Vout(T).

Circuit 1 comprises a resistor R1 across which a PTAT-type voltage Vptat(T) is available. In other words, circuit 1 is configured so that voltage Vptat(T) is available between the terminals of resistor R1. As a result, a current Iptat(T) flows through resistor R1.

Circuit 1 comprises a resistor R2 across which a CTAT-type voltage Vbe(T) is available. In other words, circuit 1 is configured so that voltage Vbe(T) is available between the terminals of resistor R2. As a result, a current Iveb(T) flows through resistor R2.

Thus, in circuit 1:

$$Ivbe ( T ) = \frac{V be ( T )}{R 2} and \qquad ( Eq 1 )$$

$$Iptat ( T ) = V ptat ( T ) / R 1 \qquad ( Eq 2 )$$

Circuit 1 further comprises a resistor R3 configured so that a current Icst(T) equal to the sum of currents Iveb(T) and Iptat(T) flows therethrough. Voltage Vout(T) is then available across resistor R3 and:

$$V out ( T ) = R 3 * ( \frac{V be ( T )}{R 2} + \frac{V ptat ( T )}{R 1} ) \qquad ( Eq 3 )$$

As an example, resistor R3 is connected between a node 100 receiving currents Iveb(T) and Iptat(T) and a node 102 configured to receive a power supply potential, for example a low power supply potential corresponding to a reference potential, for example ground GND.

As an example, to illustrate the operation of circuit 1, in FIG. 1 resistors R1 and R2 are shown as being connected in parallel between node 100 and a node 104 configured to receive a power supply potential, for example a high power supply potential Vcc. This representation is purely functional, and resistors R1 and R2 are in practice not necessarily connected as described above.

As an example, circuit 1 may comprise a circuit BUF, circuit BUF being an analog buffer circuit. Circuit BUF is connected to node 100 and is configured to deliver, on a node 106, a voltage Voutb(T) equal to voltage Vout(T) by isolating nodes 100 and 106 from each other. Voltage Voutb(T) then is the output voltage of circuit 1. As an alternative example, circuit BUF is omitted and voltage Vout(T) then is the output voltage of circuit 1.

As an example, although this is not illustrated in FIG. 1, circuit 1 comprises two bipolar transistors configured to deliver voltage Vptat(T) based on, or equal to, the difference between the two base-emitter voltages of these two bipolar transistors. For example, these two transistors are of the same PNP or NPN type, receive a same collector current, and have their bases connected together. Further, one of the two bipolar transistors is n times larger than the other, with n a positive number greater than 1. Further, the bipolar transistor of the two bipolar transistors which is the smallest has its collector and base connected to each other.

In this case:

$$V ptat ( T ) = Ut * ln ( n ) \qquad ( Eq 4 )$$

where Ut=(k*T)/q, T is the temperature in Kelvin, k is Boltzmann's constant, and q is the elementary electric charge equal to 1.6×10⁻¹⁹ coulomb.

As an example, although this is not illustrated in FIG. 1, circuit 1 comprises a bipolar transistor configured to deliver voltage Vbe(T) based on, or equal to, its base-emitter voltage. This bipolar transistor is, for example, one of the two bipolar transistors configured to generate voltage Vptat(T) or another bipolar transistor.

In this case:

$$V be ( T ) = EG - \frac{T}{Tr} * ( EG - V be ( Tr ) ) \qquad ( Eq 5 )$$

where Tr is a reference temperature equal to 300° K, EG is a constant equal to 1.181 V, and Vbe(Tr) is the base-emitter voltage value of the bipolar transistor at temperature Tr.

Using equations 4 and 5 in equation 3, there results that:

$$V out ( T ) = R 3 * ( \frac{EG}{R 2} - \frac{T * ( EG - V be ( Tr ) )}{R 2 * Tr} + \frac{Ut * ln ( n )}{R 1} ) \qquad ( Eq 6 )$$

Assuming that:

$$\frac{T}{Tr} = 1 + \frac{T - Tr}{Tr} and \qquad ( Eq 7 )$$

$$Utr = Ut * \frac{Tr}{T} = Utr * ( 1 + \frac{T - Tr}{T} ) \qquad ( Eq 8 )$$

One obtains:

$$V out ( T ) = EG * \frac{R 3}{R 2} - \frac{R 3}{R 2} * \frac{T}{Tr} * ( EG - V be ( Tr ) ) + \frac{R 3}{R 2} * \frac{T}{Tr} * Utr * ln ( n ) \qquad ( Eq 9 )$$

$$V out ( T ) = EG * \frac{R 3}{R 2} - \frac{R 3}{R 2} * ( EG - V be ( Tr ) ) - \frac{T - Tr}{Tr} * ( EG - V be ( Tr ) ) + \frac{R 3}{R 1} * Utr * ln ( n ) + \frac{T - Tr}{Tr} * \frac{R 3}{R 1} * Utr * ln ( n )$$

$$V out ( T ) = EG * \frac{R 3}{R 2} - \frac{R 3}{R 2} * ( EG - V be ( Tr ) ) + \frac{R 3}{R 1} * Utr * ln ( n ) + \frac{T - Tr}{Tr} * ( \frac{R 3}{R 1} * Utr * ln ( n ) - \frac{R 3}{R 2} * ( EG - V be ( Tr ) ) )$$

Thus, Vout(T) is the sum of a constant term Vout0 and of a term Vslope(T) varying with temperature, with:

$$V out 0 = \frac{R 3}{R 1} * Utr * ln ( n ) + \frac{R 3}{R 2} * V be ( Tr ) and \qquad ( Eq 10 )$$

$$V slope ( T ) = \frac{T - Tr}{Tr} * ( \frac{R 3}{R 1} * Utr * ln ( n ) - \frac{R 3}{R 2} * ( EG - V be ( Tr ) ) ) , \qquad ( Eq 11 )$$

where this term is zero when temperature T is equal to reference temperature Tr.

Circuit 1 is configured so that voltage Vout(T) is independent from temperature T, and thus so that:

$$\frac{R 3}{R 1} * Utr * ln ( n ) - \frac{R 3}{R 2} * ( EG - V be ( Tr ) ) = 0 \qquad ( Eq 12 )$$

In the case where the two resistors R2 and R3 are fixed (non-adjustable) and respectively correspond to two resistance values R20 and R30, equation 12 is valid if:

$$R 20 = R 1 * \frac{( EG - V be ( Tr ) )}{Utr * ln ( n )} \qquad ( Eq 13 )$$

The equation 13 can also be written as:

$$EG = \frac{R 20}{R 1} * Utr * ln ( n ) + V be ( Tr ) or also \qquad ( Eq 14 )$$

$$Utr * ln ( n ) = \frac{R 1}{R 20} * ( EG - V be ( Tr ) ) \qquad ( Eq 15 )$$

Resistor R2 is sized to have a fixed value R20 satisfying the above equation 13.

It is then expected for voltage Vout(T) to be constant and independent from temperature and that:

$$V out ( T ) = EG * \frac{R 30}{R 20} = EG * Gain with \qquad ( Eq 16 )$$

$$Gain = \frac{R 30}{R 20} \qquad ( Eq 17 )$$

Thus, value R30 is selected so that R30=Gain*R20, Gain being a factor determined by the targeted value of Vout(T).

Taking the equations 14 and 17, one obtains:

$$gain * EG = \frac{R 30}{R 20} * EG = \frac{R 30}{R 1} * Utr * ln ( n ) + \frac{R 30}{R 20} * V be ( Tr ) \qquad ( Eq 18 )$$

Further, using the equation 15, the equations 10 and 11 can be written as:

$$V out 0 = \frac{R 3}{R 20} * ( EG - V be ( Tr ) ) + \frac{R 3}{R 2} * V be ( Tr ) and \qquad ( Eq 19 )$$

$$V slope ( T ) = \frac{T - Tr}{Tr} * ( EG - V be ( Tr ) ) * ( \frac{R 3}{R 20} - \frac{R 3}{R 2} ) \qquad ( Eq 20 )$$

FIG. 2 shows, in more detailed fashion, an example of a bandgap circuit 1.

Circuit 1 comprises resistor R1, a bipolar transistor T1, and a bipolar transistor T2 of the same NPN or PNP type as transistor T1 and n times larger than transistor T1. Transistors T1 and T2 are configured to deliver, across resistor R1, voltage Vptat(T) equal to the difference between their base-emitter voltages, and defined by the equation 5. Current Iptat(T) then flows through resistor R1.

For example, transistors T1 and T2 are of NPN type. For example, transistor T1 has its base coupled, for example connected, to its collector, and its emitter connected to node 102, transistor T2 having its base connected to the base of transistor T1, and its emitter coupled to node 102 by resistor R1. For example, the collectors of the two transistors T1 and T2 are coupled to node 104 by MOS transistors, respectively M1 and M2, in this example with a P channel, transistors M1 and M2 being assembled as a current mirror. For example, transistors M1 and M2 are identical.

Circuit 1 comprises resistor R2 and a bipolar transistor T3 of the same NPN or PNP type as transistors T1 and T2. Transistor T3 is configured to deliver, across resistor R2, its base-emitter voltage Vbe(T) such as defined by the equation for Vbe(T). Current Ivbe(T) then flows through resistor R2.

For example, transistor T3 has its base coupled to its collector by a buffer circuit, for example a MOS transistor M4, for example with an N channel in this example, assembled as a source follower. Further, transistor T3 has, for example, its emitter connected to node 102 and its collector coupled to the node by a MOS transistor M3, in this example with a P channel, transistor M3 being for example assembled as a current mirror with transistors M1 and M2. Further, transistor T3 has its base coupled to node 104 via a MOS transistor M5, in this example with a P channel. For example, transistor M5 has its drain connected to the drain of transistor M4.

Circuit 1 further comprises node 100 and resistor R3, resistor R3 being connected between node 100 and node 102.

Circuit 1 comprises a current mirror configured to supply current Iptat(T) to node 100. For example, this current mirror comprises transistor M2 and a MOS transistor M6 with a channel of the same type as that of transistor M2, transistor M6 being assembled as a current mirror with transistor M2. In other words, transistors M1, M2, and M6 form a current mirror configured to bias transistor T1 and to supply node 100 with a copy of the current Iptat(T) flowing through resistor R3.

Circuit 1 further comprises a current mirror configured to supply current Ivbe(T) to node 100, or, in other words, to supply node 100 with a copy of the current Iveb(T) flowing through resistor R2. For example, this current mirror comprises transistor M5 and a MOS transistor M7 having a channel of the same type as that of transistor M5, transistor M7 being assembled as a current mirror with transistor M5.

Thus, current Icst(T) flows through resistor R3 and voltage Vout(T) is available across resistor R3.

In the case where resistors R2 and R3 are fixed and have respective values R20 and R30, value R20 is selected to satisfy the equation 13 and value R30 is selected to satisfy the equation 17. However, in practice, manufacturing dispersions cause errors in the above-described equations, for example in resistance values R20 and R30. As a result, for example, at temperature Tr, voltage Vout(T) may not be equal to the target value EG*Gain.

It is thus generally provided to be able to set the value of resistors R2 and R3 to compensate for the effect of manufacturing dispersions, at least at temperature Tr.

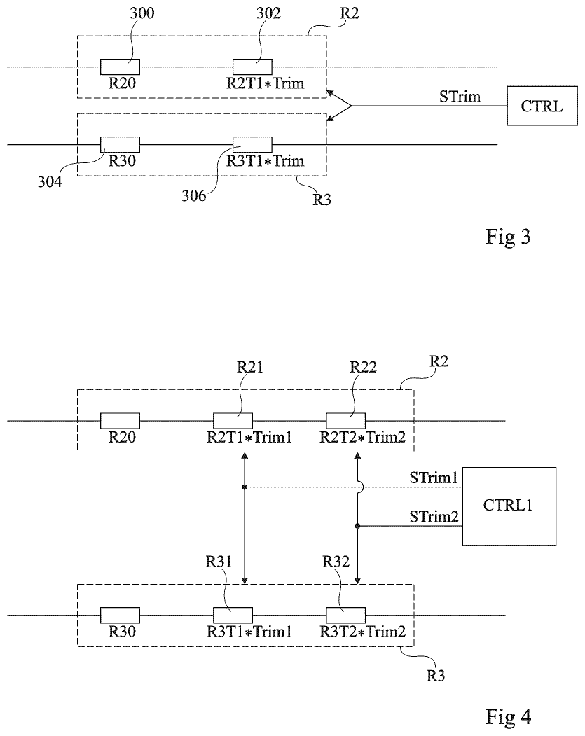

FIG. 3 schematically shows an example of calibration, or setting, of the circuits of FIGS. 1 and 2.

More specifically, FIG. 3 illustrates an example where resistors R2 and R3 are each implemented by a series association of a constant resistor and of a single controllable resistor. In other words, each of resistors R2 and R3 comprises a fixed part and a single controllable part.

Thus, resistor R2 comprises a fixed part (or fixed resistor) 300 and a controllable part (or controllable resistor) 302. Resistors 300 and 302 are in series between the terminals of resistor R2. Similarly, resistor R3 comprises a fixed part (or fixed resistor) 304 and a controllable part (or controllable resistor) 306. Resistors 304 and 306 are in series between the terminals of resistor R3.

The fixed part 300 of resistor R2 has a resistance value R20. The fixed part 304 of resistor R3 has a resistance value R30.

The controllable part 302 of resistor R2 has a value equal to the product of a set value R2T1 by an integer Trim. Integer Trim is determined by a control signal sTrim. In other words, the resistance value of part 302 of resistor R2 is equal to R2T1*Trim.

The controllable part 306 of resistor 32 has a value equal to the product of a set value R3T1 by integer Trim. Again, integer Trim is determined by a control signal sTrim. In other words, the resistance value of part 306 of resistor R3 is equal to R3T1*Trim.

As an example, number Trim is between −8 and +8.

Thus, both resistors R2 and R3 are controlled by the same signal sTrim. Circuit 1 (not shown in detail in FIG. 3) then comprises a control circuit CTRL configured to supply signal sTrim for controlling resistors R2 and R3.

The values of resistances R2 and R3 can thus be written as:

$$R 2 = R 20 + R 2 T 1 * Trim \qquad ( Eq 21 )$$

$$R 3 = R 30 + R 3 T 1 * Trim \qquad ( Eq 22 )$$

Values R20 and R30 are selected so that R20 satisfies the equation 13 and that R30 satisfies the equation 17. Thus, in the absence of a dispersion, the equations 13 and 14 are valid if Trim is zero, and thus if there is no setting of resistors R2 and R3, which is logical.

The equation 13 can be written as:

$$R 20 = R 1 * ( EG - V be ( Tr ) ) / ( Utr * ln ( n ) ) \qquad ( Eq 23 )$$

As an example, to simplify the description of FIG. 3, set values R2T1 and R3T1 are each taken to be equal to a value R0T1, and factor Gain is selected to be equal to 1, whereby:

$$R 2 = R 20 * ( 1 + \frac{R 0 T 1}{R 20} * Trim ) = R 3 \qquad ( Eq 24 )$$

Using the equation 24, the equations 19 and 20 can then be written as:

$$V out 0 = EG + trim * \frac{R 0 T 1}{R 20} * ( EG - V be ( Tr ) ) and \qquad ( Eq 25 )$$

$$V slope ( T ) = \frac{T - Tr}{Tr} * ( EG - V be ( Tr ) ) * trim * \frac{R 0 T 1}{R 20} \qquad ( Eq 26 )$$

Thus, if at temperature Tr, voltage Vout(Tr) is not equal to EG in this example where factor Gain is equal to 1, it is possible, by modifying the value of number Trim, to take voltage Vout(Tr) back to value EG. However, the value of number Trim causes a change in the value of factor R20/R1*(1+(R0T1/R20)*Trim)*Utr*ln(n)−(Eg−Vbe(T)), and thus in the slope of part Vslope(T) of voltage Vout(T).

Symmetrically, a change in number Trim to modify the slope of part Vslope(T) of voltage Vout(T) necessarily causes a change in the absolute value of part Vout0 of voltage Vout(T).

This interdependence of the setting of value Vout0 and of the slope of part Vslope(T) is also present when factor G is selected to be different from 1, although this is not detailed herein.

The interdependence of the setting of the constant value Vout0 of voltage Vout(T) and of the setting of the slope of part Vslope(T) of voltage Vout(T) is not desirable, for example in applications where voltage Vout(T) must have as constant a value as possible over an entire temperature range.

It is further preferable for signal sTrim to control both resistors R2 and R3 simultaneously and in the same way to avoid a complex setting procedure.

To overcome the above disadvantages, it is here provided that: each of resistors R2 and R3 comprises a fixed part and N controllable parts, with N being an integer greater than or equal to 2; each controllable part is equal to the product of a set value of the controllable part by an integer determined by a signal for controlling this controllable part; each of the N controllable parts of resistor R2 is associated with a corresponding controllable part of resistor R3; a control circuit is configured to deliver, for each controllable part, the same control signal to this controllable part and to the controllable part which is associated therewith; and at least one controllable part has a set value different from that of the controllable part which is associated therewith.

Indeed, as will be detailed hereafter in examples, this enables, for each pair of associated controllable parts comprising a controllable part of resistor R2 and a part of resistor R3, the effect of a change in the control signal of this pair of associated controllable parts to be independent from the effect of a change in the control signal of another pair of associated controllable parts.

More particularly, the set values of each of the controllable parts of a pair of associated controllable parts may be determined so that a change in the control signal of this pair of associated controllable parts results in: a change in value Vout0 and in the slope of voltage Vslope(T) simultaneously; or a change in value Vout0 without for this to change the slope of voltage Vslope(T); or a change in the slope of voltage Vslope(T) with no change in value Vout0.

It is thus possible, with N signals for controlling the N pairs of associated controllable parts, to perform N settings independent from one another.

FIG. 4 shows, schematically, an example of a mode of calibration, or setting, of bandgap circuit 1, in the case where resistors R2 and R3 are such as defined above, that is, each with N controllable parts, the controllable parts of resistors R2 and R3 being associated in pairs comprising a controllable part of resistor R2 and a controllable part of resistor R3, both controlled by a same signal.

In the example of FIG. 4, N is equal to 2.

In FIG. 4, only the resistors R2 and R3 of circuit 1 and the circuit CTRL1 for controlling resistors R2 and R3 are detailed.

Resistor R2 comprises a fixed part (or resistor) R20 and N controllable parts (or resistors) R2i, with i being an integer ranging from 1 to N. Resistors R20 and R2i are series-connected between the terminals of resistor R2. In the example of FIG. 4 where N is equal to 2, resistor R2 thus comprises two controllable parts R21 and R22.

Similarly, resistor R3 comprises a fixed part (or resistor) R30 and N controllable parts (or resistors) R3i. Resistors R30 and R3i are series-connected between the terminals of resistor R3. In the example of FIG. 4 where N is equal to 2, resistor R3 thus comprises two controllable parts R31 and R32.

Each part R2i of resistor R2 is associated with a corresponding part R3i of resistor R3. In the example of FIG. 4 where N is equal to 2, part R21 of resistor R2 is associated with the corresponding part R31 of resistor R3, and part R22 of resistor R2 is associated with the corresponding part R32 of resistor R3.

Each part R2i of resistor R2 has a resistance value equal to the product of a set value R2Ti of part R2i by an integer Trimi, the value of number Trimi being determined by a signal STrimi for controlling part R2i. Thus, in the example of FIG. 4 where N is equal to 2, part R21 is equal to R2T1*Trim1 and part R22 is equal to R2T2*Trim2. As an example, each number Trimi can take all the integer values ranging from an integer value −A to an integer value +A, with A being a positive integer value, for example equal to 8.

Symmetrically, each part R3i of resistor R3 has a resistance value equal to the product of a set value R3Ti of part R3i by the corresponding integer Trimi. Thus, in the example of FIG. 4 where N is equal to 2, part R31 is equal to R3T1*Trim1 and part R32 is equal to R3T2*Trim2.

In resistors R2 and R3, for each pair of associated controllable parts R2i and R3i, the two controllable parts R2i and R3i in the pair are controlled by the same signal STrimi determining the value of number Trimi. For example, in FIG. 4 where N is equal to 4, the associated controllable parts R21 and R31 are controlled by the same signal STrim1 determining the value of number Trim1, and the associated controllable parts R22 and R32 are controlled by the same signal STrim2 determining the value of number Trim2.

Signals STrimi are delivered by circuit CTRL1.

Numbers Trimi are determined independently from one another, or, in other words, signals STrimi are independent from one another.

The resistance values of the fixed parts R20 and R30 of resistors R2 and R3 are selected to satisfy the equations 13 and 17.

Thus, in FIG. 4:

$$\begin{matrix}R 2 = R 20 + R 2 T 1 * Trim 1 + R 2 T 2 * Trim 2 \\ R 2 = R 20 * ( 1 + \frac{R 2 T 1}{R 20} * Trim 1 + \frac{R 2 T 2}{R 20} * Trim 2 )\end{matrix} and \qquad ( Eq 27 )$$

$$\begin{matrix}R 3 = R 30 + R 3 T 1 * Trim 1 + R 3 T 2 * Trim 2 \\ R 3 = R 30 * ( 1 + \frac{R 3 T 1}{R 30} * Trim 1 + \frac{R 3 T 2}{R 30} * Trim 2 )\end{matrix} \qquad ( Eq 28 )$$

In the equation 27, it is assumed that:

$$x = \frac{R 2 T 1}{R 20} * Trim 1 + \frac{R 2 T 2}{R 20} * Trim 2 \qquad ( Eq 29 )$$

Since x is in practice small as compared with 1, the following series expansion is used:

$$\frac{1}{1 + x} \approx 1 - x \qquad ( Eq 30 )$$

Thereby:

$$\frac{1}{R 2} \approx \frac{1}{R 20} * ( 1 - \frac{R 2 T 1}{R 20} * Trim 1 - \frac{R 2 T 2}{R 20} * Trim 2 ) \qquad ( Eq 31 )$$

And thus:

$$\frac{R 3}{R 2} \approx \frac{R 30}{R 20} * ( 1 - \frac{R 2 T 1}{R 20} * Trim 1 - \frac{R 2 T 2}{R 20} * Trim 2 ) * ( 1 + \frac{R 3 T 1}{R 30} * Trim 1 + \frac{R 3 T 2}{R 30} * Trim 2 ) \qquad ( Eq 32 )$$

By replacing, in equation 19: R3/R2 with its expression according to equation 32, and R3 with its expression according to equation 32 in the term R3/R20, one thus obtains:

$$V out 0 = \frac{R 30 + R 3 T 1 * Trim 1 + R 3 T 2 * Trim 2}{R 20} * ( EG - V be ( Tr ) + \frac{R 30}{R 20} * ( 1 - \frac{R 2 T 1}{R 20} Trim 1 - \frac{R 2 T 2}{R 20} * Trim 2 ) * ( 1 + \frac{R 3 T 1}{R 30} * Trim 1 + \frac{R 3 T 2}{R 30} * Trim 2 ) * V be ( Tr ) ) \qquad ( Eq 33 )$$

$$V out 0 = \frac{R 30}{R 20} * EG - \frac{R 30}{R 20} * V be ( Tr ) + \frac{R 3 T 1}{R 20} * Trim 1 * EG - \frac{R 3 T 1}{R 20} * Trim 1 * V be ( Tr ) + \frac{R 3 T 2}{R 20} * Trim 2 * EG - \frac{R 3 T 2}{R 20} * Trim 2 * V be ( Tr ) + \frac{R 30}{R 20} * ( 1 + \frac{R 3 T 1}{R 30} * Trim 1 + \frac{R 3 T 2}{R 30} * Trim 2 ) * V be ( Tr ) - \frac{R 30}{R 20} * \frac{R 2 T 1}{R 20} * Trim 1 * ( 1 + \frac{R 3 T 1}{R 30} * Trim 1 + \frac{R 3 T 2}{R 30} * Trim 2 ) * V be ( Tr ) - \frac{R 30}{R 20} * \frac{R 2 T 2}{R 20} * Trim 2 * ( 1 + \frac{R 3 T 1}{R 30} * Trim 1 + \frac{R 3 T 2}{R 30} * Trim 2 ) * V be ( Tr ) \qquad ( Eq 34 )$$

Neglecting all terms in Trim1*Trim2, Trim1*Trim1, and Trim2*Trim2 in the above expression for equation 34, one then obtains:

$$V out 0 = \frac{R 30}{R 20} * EG - \frac{R 30}{R 20} * Vbe ( Tr ) + \frac{R 3 T 1}{R 20} * Trim 1 * EG - \frac{R 3 T 1}{R 20} * Trim 1 * Vbe ( Tr ) + \frac{R 3 T 2}{R 20} * Trim 2 * EG - \frac{R 3 T 2}{R 20} * Trim 2 * Vbe ( Tr ) + \frac{R 30}{R 20} * ( 1 + \frac{R 3 T 1}{R 30} * Trim 1 + \frac{R 3 T 2}{R 30} * Trim 2 ) * Vbe ( Tr ) - \frac{R 30}{R 20} * \frac{R 2 T 1}{R 20} * Trim 1 * Vbe ( Tr ) - \frac{R 30}{R 20} * \frac{R 2 T 2}{R 20} * Trim 2 * Vbe ( Tr ) \qquad ( Eq 35 )$$

By expanding the expression 35, one obtains:

$$V out 0 = \frac{R 30}{R 20} * EG - \frac{R 30}{R 20} * Vbe ( Tr ) + \frac{R 3 T 1}{R 20} * Trim 1 * EG - \frac{R 3 T 1}{R 20} * Trim 1 * Vbe ( Tr ) + \frac{R 3 T 2}{R 20} * Trim 2 * EG - \frac{R 3 T 2}{R 20} * Trim 2 * Vbe ( Tr ) + \frac{R 30}{R 20} * Vbe ( Tr ) + \frac{R 3 T 1}{R 20} * Trim 1 * Vbe ( Tr ) + \frac{R 3 T 2}{R 20} * Trim 2 * Vbe ( Tr ) - \frac{R 30}{R 20} * \frac{R 2 T 1}{R 20} * Trim 1 * Vbe ( Tr ) - \frac{R 30}{R 20} * \frac{R 2 T 2}{R 20} * Trim 2 * Vbe ( Tr ) \qquad ( Eq 36 )$$

$$V out 0 = \frac{R 30}{R 20} * EG + \frac{R 3 T 1}{R 20} * Trim 1 * EG + \frac{R 3 T 2}{R 20} * Trim 2 * EG - \frac{R 30}{R 20} * \frac{R 2 T 1}{R 20} * Trim 1 * Vbe ( Tr ) - \frac{R 30}{R 20} * \frac{R 2 T 2}{R 20} * Trim 2 * Vbe ( Tr )$$

And thus:

$$V out 0 = Gain * ( EG + Trim 1 * ( \frac{R 3 T 1}{R 30} * EG - \frac{R 2 T 1}{R 20} * Vbe ( Tr ) ) + Trim 2 * ( \frac{R 3 T 2}{R 30} EG - \frac{R 2 T 2}{R 20} * Vbe ( Tr ) ) ) \qquad ( Eq 37 )$$

Similarly, by replacing, in equation 20: R3/R2 with its expression according to equation 32, and R3 with its expression according to the equation 28 in the R3/R20 term, one then obtains:

$$Vslope ( T ) = \frac{T - Tr}{Tr} * ( \frac{R 30 + R 3 T 1 * Trim 1 + R 3 T 2 * Trim 2}{R 20} * ( EG - Vbe ( Tr ) ) - \frac{R 30}{R 20} * ( 1 - \frac{R 2 T 1}{R 20} * Trim 1 - \frac{R 2 T 2}{R 20} * Trim 2 ) * ( 1 + \frac{R 3 T 1}{R 30} * Trim 1 + \frac{R 3 T 2}{R 30} * Trim 2 ) * ( EG - Vbe ( Tr ) ) ) \qquad ( Eq 38 )$$

$$Vslope ( T ) = \frac{T - Tr}{Tr} * ( \frac{R 30 + R 3 T 1 * Trim 1 + R 3 T 2 * Trim 2}{R 20} * ( EG - Vbe ( Tr ) ) - \frac{R 30}{R 20} * ( 1 + \frac{R 3 T 1}{R 30} * Trim 1 + \frac{R 3 T 2}{R 30} * Trim 2 ) * ( EG - Vbe ( Tr ) ) + * \frac{R 30}{R 20} ( \frac{R 2 T 1}{R 20} * Trim 1 ) * ( 1 + \frac{R 3 T 1}{R 30} * Trim 1 + \frac{R 3 T 2}{R 30} * Trim 2 ) * ( EG - Vbe ( Tr ) ) + \frac{R 30}{R 20} ( \frac{R 2 T 2}{R 20} * Trim 2 ) * ( 1 + \frac{R 3 T 1}{R 30} * Trim 1 + \frac{R 3 T 2}{R 30} * Trim 2 ) * ( EG - Vbe ( Tr ) ) )$$

Neglecting, as for Vout0, the terms in Trim1*Trim1, Trim1*Trim2, and Trim2*Trim2, one obtains:

$$Vslope ( T ) = \frac{T - Tr}{Tr} * ( \frac{R 30 + R 3 T 1 * Trim 1 + R 3 T 2 * Trim 2}{R 20} * ( EG - Vbe ( Tr ) ) - * ( R 30 + \frac{R 3 T 1}{R 20} * Trim 1 + \frac{R 3 T 2}{R 20} * Trim 2 ) * ( EG - Vbe ( Tr ) ) + * Gain ( \frac{R 2 T 1}{R 20} * Trim 1 ) * ( EG - Vbe ( Tr ) ) + Gain ( \frac{R 2 T 2}{R 20} * Trim 2 ) * ( EG - Vbe ( Tr ) ) ) \qquad ( Eq 39 )$$

Whereby:

$$Vslope ( T ) = Gain * \frac{T - Tr}{Tr} * ( EG - Vbe ( Tr ) ) * ( ( \frac{R 2 T 1}{R 20} * Trim 1 ) + ( \frac{R 2 T 2}{R 20} * Trim 2 ) )$$

In the above equations 37 and 40, the effects of the changes of numbers Trimi add up in the expressions of Vout0 and Vslope(T), without for the effect of a change in one of numbers Trimi to affect the effect of a change in another one of numbers Trimi. In particular, the equation 40 shows that the slope of the term Vslope(T) does not depend on the setting of R3.

Thus, as already indicated hereabove, the set values of each of the controllable parts R2i and R3i of a pair of associated controllable parts can be determined so that a change in signal STrimi, and thus in number Trimi, corresponding to this pair of controllable parts R2i and R3i, results in: a change in value Vout0 and in the slope of voltage Vslope(T) simultaneously; or a change in value Vout0 without for this to change the slope of voltage Vslope(T); or a change in the slope of voltage Vslope(T) with no change in value Vout0.

Thus, a first number Trimi may be modified (or used) to implement one of the three modifications listed hereabove, while a second Trimi number may be modified (or used) to implement another one of the three modifications listed hereabove.

For example, considering a factor Gain equal to 1 (R30=R20), and a pair R2i, R3i of given index i, by providing that R2Ti=R3Ti for this index i, a change in the number Trimi corresponding to this index results in a simultaneous change in voltage Vout0 and in the slope of voltage Vslope(T). For example, by applying this to the pair R21, R31 of index i equal to 1, that is, by selecting R2T1=R3T1=R0T1, one obtains:

$$Vslope ( T ) = EG + Trim 1 * \frac{R 0 T 1}{R 20} ( EG - Vbe ( Tr ) ) + Trim 2 * ( \frac{R 3 T 2}{R 20} * EG - \frac{R 2 T 2}{R 20} * Vbe ( Tr ) ) \qquad ( Eq 41 )$$

$$and$$

$$Vslope ( T ) = \frac{T - Tr}{Tr} * ( EG - Vbe ( Tr ) ) * ( \frac{R 0 T 1}{R 20} * Trim 1 + \frac{R 2 T 2}{R 20} * Trim 2 ) \qquad ( Eq 42 )$$

One then finds, in the expression of Vout0 according to equation 41, the right-hand side of equality of the equation 25 with Trim=Trim1, and, in the expression of Vslope(T) according to equation 42, the right-hand side of equality for equation 26 with Trim=Trim1.

In other words, by taking, for a pair R2i, R3i of given index i, set values R2Ti and R3Ti equal to each other, number Trimi can be used to implement the setting simultaneously modifying the value of voltage Vout0 and the slope of voltage Vslope(T) as is the case in FIG. 3. However, as compared with FIG. 3, it is then possible to use a pair R2i, R3i of different index i to carry out another setting, for example to modify the value of voltage Vout0 without modifying the value of the slope of voltage Vslope(T) or to modify the value of this slope without modifying the value of voltage Vout0.

As another example, considering a unit factor Gain and a pair R2i, R3i of given index i, the corresponding set values R2Ti and R3Ti can be determined so that a change in the number Trimi corresponding to this given index i results in a change in the slope of voltage Vslope(T), without for this to modify value Vout0. As an example, to achieve this, the set values R2Ti and R3Ti of this pair R2i, R3i of given index i are selected so that R2Ti*Vbe(Tr)=R3Ti*EG. For example, by applying this to the pair R21, R31 of index i equal to 1, that is, by selecting R2T1*Vbe(Tr)=R3T1*EG in the above equations 37 and 40, one obtains:

$$Vout 0 = EG + Trim 2 * ( \frac{R 3 T 2}{R 20} * EG - \frac{R 2 T 2}{R 20} * Vbe ( Tr ) ) \qquad ( Eq 43 )$$

$$and$$

$$Vslope ( T ) = \frac{T - Tr}{Tr} * ( EG - Vbe ( Tr ) ) * ( \frac{R 2 T 1}{R 20} * Trim 1 + \frac{R 2 T 2}{R 20} * Trim 2 ) \qquad ( Eq 44 )$$

Thus, in equations 43] and 44], a change in number Trim1 only changes the value of the slope of voltage Vslope(T), with no change in value Vout0.

As another example, considering a unit factor Gain and a pair R2i, R3i of given index i, the corresponding set values R2Ti and R3Ti can be determined so that a change in the number Trimi corresponding to this given index i results in a change in value Vout0, without for this to modify the slope of voltage Vslope(T). As an example, to achieve this, the set values R2Ti and R3Ti of this pair R2i, R3i of given index i are selected so that R2Ti is zero. For example, by applying this to the pair R21, R31 of index i equal to 1, that is, by selecting R2T1=0 in the above equations 37 and 40, one obtains:

$$Vout 0 = EG + Trim 1 * ( \frac{R 3 T 1}{R 20} * EG ) + Trim 2 * ( \frac{R 3 T 2}{R 20} * EG - \frac{R 2 T 2}{R 20} * Vbe ( Tr ) ) \qquad ( Eq 45 )$$

$$and$$

$$Vslope ( T ) = \frac{T - Tr}{Tr} * ( EG - Vbe ( Tr ) ) * \frac{R 2 T 2}{R 20} * Trim 2 \qquad ( Eq 46 )$$

Thus, in equations 45 and 46, a change in number Trim1 only changes value Vout0, with no change in the value of the slope of voltage Vslope(T).

There has been described hereabove in relation with FIG. 4 an example where N is equal to 2. However, in other examples, N may be equal to 3. Equations 37 and 40 then become:

$$Vout 0 = Gain * ( EG + Trim 1 * ( \frac{R 3 T 1}{R 30} * EG - \frac{R 2 T 1}{R 20} * Vbe ( Tr ) ) + Trim 2 * ( \frac{R 3 T 2}{R 30} EG - \frac{R 2 T 2}{R 20} * Vbe ( Tr ) ) + Trim 3 * ( \frac{R 3 T 3}{R 30} EG - \frac{R 2 T 3}{R 20} * Vbe ( Tr ) ) ) \qquad ( Eq 47 )$$

$$and$$

$$Vslope ( T ) = Gain * ( EG - Vbe ( Tr ) ) * \frac{T - Tr}{Tr} * ( ( \frac{R 2 T 1}{R 20} * Trim 1 ) + ( \frac{R 2 T 2}{R 20} * Trim 2 ) + ( \frac{R 2 T 3}{R 20} * Trim 3 ) ) \qquad ( Eq 48 )$$

In the N=3 case, as an example, a first number Trimi, for example Trim1, is used to simultaneously set the slope of voltage Vslope(T) and the value of voltage Vout0, a second number Trimi, for example Trim2, is used to set voltage Vout0 without changing the slope of voltage Vslope(T), and a third number Trimi, for example, Trim3, is used to set the slope of voltage Vslope(T) without modifying the value of voltage Vout0. For example, for this purpose, in the case of a unit factor Gain, the set values are selected as follows:

$$R 2 T 1 = R 3 T 1 ;$$

$$R 2 T 2 = 0 ;$$

$$and$$

$$R 2 T 3 * Vbe ( Tr ) = R 3 T 3 * EG .$$

By applying this to equations 47 and 48 (with Gain=1), one then obtains:

$$Vout 0 = EG + Trim 1 * ( \frac{R 2 T 1}{R 20} * ( EG - Vbe ( Tr ) ) ) + Trim 2 * ( \frac{R 3 T 2}{R 20} * EG ) \qquad ( Eq 49 )$$

$$and$$

$$Vslope ( T ) = \frac{T - Tr}{Tr} * ( EG - Vbe ( Tr ) ) * ( \frac{R 2 T 1}{R 20} * Trim 1 + \frac{R 2 T 3}{R 20} * Trim 3 )$$

These equations 49 and 50 effectively show that:
a change in number Trim1 causes a simultaneous change in voltage Vout0 and in the slope of voltage Vslope(T);
a change in number Trim2 only causes a change in voltage Vout0; and
a change in number Trim3 only causes a change in the slope of voltage Vslope(Tr).

More generally, equations 37, 40, 47 and 48 can be generalized to any N greater than or equal to 2, where voltage Vout0 and voltage Vslope(T) can then be written as:

$$Vout 0 = Gain * ( EG + {\sum }_{i = 1}^{N} Trimi * ( \frac{R 3 Ti}{R 30} * EG - \frac{R 2 Ti}{R 20} * Vbe ( Tr ) ) ) \qquad ( Eq 51 )$$

$$and$$

$$Vslope ( T ) = Gain * \frac{T - Tr}{Tr} * ( EG - Vbe ( Tr ) ) * {\sum }_{i = 1}^{N} \frac{R 2 Ti}{R 20} * Trimi \qquad ( Eq 52 )$$

In the above-described examples, factor Gain has been taken equal to 1. However, in other examples, circuit 1 may be sized so that, at temperature Tr, voltage Vout(T) is equal to the product of value EG multiplied by factor Gain having a value other than 1.

For example, taking the above example where N is equal to 3 and where Trim1 enables to simultaneously set value Vout0 and the slope of Vslope(T), Trim2 enables to set voltage Vout0 without modifying the slope of voltage Vslope(T) and Trim3 enables to set the slope of voltage Vslope(T) without modifying the value of voltage Vout0, the set values are selected as follows:

$$R 3 T 1 = Gain * R 2 T 1 ;$$

$$R 2 T 2 = 0 ;$$

$$and$$

$$Gain * R 2 T 3 * Vbe ( Tr ) = R 3 T 3 * EG .$$

By applying this to the above equations 51 and 52 in the case N=3, one then obtains:

$$Vout 0 = Gain * ( EG + {\sum }_{i = 1}^{3} Trimi * ( \frac{R 3 Ti}{R 30} * EG - \frac{R 2 Ti}{R 20} * Vbe ( Tr ) ) ) \qquad ( Eq 53 )$$

$$Vout 0 = Gain * EG + Trim 1 * ( \frac{R 3 T 1}{R 20} * EG - \frac{Gain * R 2 T 1}{R 20} * Vbe ( Tr ) ) + Trim 2 * ( \frac{R 3 T 2}{R 20} * EG - \frac{Gain * R 2 T 2}{R 20} * Vbe ( Tr ) ) + Trim 3 * ( \frac{R 3 T 3}{R 20} * EG - \frac{Gain * R 2 T 3}{R 20} * Vbe ( Tr ) )$$

$$Vout 0 = Gain * EG + Trim 1 * ( \frac{R 3 T 1}{R 20} * ( EG - Vbe ( Tr ) ) ) + Trim 2 * \frac{R 3 T 2}{R 20} * EG$$

$$Vslope ( T ) = \frac{T - Tr}{Tr} * Gain * ( EG - Vbe ( Tr ) ) * {\sum }_{i = 1}^{3} \frac{R 2 T 1}{R 20} * Trimi \qquad ( Eq 54 )$$

$$Vslope ( T ) = \frac{T - Tr}{Tr} * ( EG - Vbe ( Tr ) ) * ( \frac{Gain * R 2 T 1}{R 20} * Trim 1 + \frac{Gain * R 2 T 2}{R 20} * Trim 2 + \frac{Gain * R 2 T 3}{R 20} * Trim 3 )$$

$$Vslope ( T ) = \frac{T - Tr}{Tr} * ( EG - Vbe ( Tr ) ) * ( \frac{Gain * R 2 T 1}{R 0} * Trim 1 + \frac{Gain * R 2 T 3}{R 0} * Trim 3 )$$

It can effectively be observed, in equations 53 and 54, that a change in Trim1 changes the slope of Vslope(T) and of value Vout0, that a change in Trim2 only changes value Vout0 without changing the slope of Vslope(T), and that a change in Trim3 only changes the slope of Vslope(T) without changing the value of Vout0.

Various embodiments and variants have been described. Those skilled in the art will understand that certain features of these various embodiments and variants may be combined, and other variants will occur to those skilled in the art. In particular, those skilled in the art will be capable of adapting the above description to the case where N is greater than 3, although, preferably, N is equal to 2 or 3, and is even more preferably equal to 3.

Finally, the practical implementation of the described embodiments and variants is within the abilities of those skilled in the art based on the functional indications given hereabove. In particular, those skilled in the art are capable of adapting the example of circuit 1 of FIG. 2, where potential Vcc is positive with respect to reference potential GND, to the case where potential Vcc is negative with respect to the reference potential by replacing all NPN-type bipolar transistors with PNP-type bipolar transistors, and, for example, all P-channel MOS transistors with N-channel MOS transistors and vice versa.

1. A bandgap circuit, comprising:
a first resistor configured to receive a voltage proportional to absolute temperature across its terminals;
a second resistor configured to receive a voltage complementary to absolute temperature across its terminals;
a third resistor, wherein a current flow through the third resistor is equal to a sum of a current flow through the first resistor and a current flow through the second resistor;
wherein each of the second and third resistors comprises a fixed part and N controllable parts, with N being an integer number greater than or equal to 2;
wherein each controllable part is equal to a product of a set value of said controllable part and an integer number determined by a control signal of said controllable part;
wherein each of the N controllable parts of the second resistor is associated with a corresponding one of the N controllable parts of the third resistor; and
a control circuit configured to supply, for each controllable part, a same control signal to the controllable part for one of the first and second resistors and to the controllable part of the other of the first and second resistors associated therewith; and
wherein at least one controllable part has a set value different from that of the controllable part associated therewith.

2. The bandgap circuit according to claim 1, wherein a pair of a controllable part of the third resistor and the associated controllable part of the second resistor satisfies one of following relationships:
the set value of the controllable part of the third resistor is equal to Gain times the set value of the associated controllable part of the second resistor;
the set value of the controllable part of the second resistor is null; or
the set value of the controllable part of the third resistor is equal to Gain*Vbe(Tr)/EG times the set value of the associated controllable part of the second resistor, with Gain is equal to a ratio of a resistance value of the fixed part of the third resistor by a resistance value of the fixed part of the second resistor, Vbe(Tr) is a value of a voltage complementary to absolute temperature taken at a temperature Tr, Tr is a reference temperature, and EG is a constant equal to 1.181 V.

3. The bandgap circuit according to claim 2, wherein another pair of a controllable part of the third resistor and the associated controllable part of the second resistor verifies another of said relationships.

4. The bandgap circuit according to claim 3, wherein:
N is greater than or equal to 3; and
yet another pair of a controllable part of the third resistor and the associated controllable part of the second resistor verifies yet another of said relationships.

5. The bandgap circuit according to claim 1, wherein the fixed parts of the second and third resistors have the same resistance value.

6. The bandgap circuit according to claim 1, wherein a resistance value of the fixed part of the second resistor is equal to (EG−Vbe(Tr))/(Utr*ln(n)) times a resistance value of the first resistor, where: EG is a constant equal to 1.181 V; Vbe(Tr) is a value of a voltage complementary to absolute temperature taken at a reference temperature Tr; Utr is equal to (k*Tr)/q, with k the Boltzmann constant and q the elementary electric charge; and n is a size ratio between two bipolar transistors configured so that a difference between base-emitter voltages of these two bipolar transistors determines and is equal to a voltage proportional to absolute temperature.

7. The bandgap circuit according to claim 1, further comprising:
two bipolar transistors of a first type among NPN and PNP having their bases connected to each other;
a first of the two bipolar transistors has its emitter connected to a node for applying a reference potential, and its base and collector coupled with, preferably connected to, each other;
a second of the two bipolar transistors is n times larger than the first of the two bipolar transistors, and has its emitter coupled in series through the first resistor to the node for applying the reference potential;
a third bipolar transistor of the first type having its base and collector coupled with each other by a buffer circuit;
the emitter of the third bipolar transistor is connected to the node for applying the reference potential; and
the base of the third bipolar transistor is coupled with the node for applying the reference potential via the second resistor.

8. The band-gap circuit according to claim 7, further comprising:
a first current mirror configured to supply a copy of a current flowing through the first resistor to a current summing node, and to bias the first of said two bipolar transistors;
a second current mirror configured to provide a copy of a current flowing through the second resistor to the current summation node; and
wherein the third resistor couples the current summation node with the node for applying a reference potential.

9. The bandgap circuit according to claim 8, wherein an additional buffer circuit is connected to the current summation node, and is configured to provide an output voltage equal to the voltage across the third resistor.

10. The circuit according to claim 8, wherein:
the collectors of the two bipolar transistors are coupled with a node for applying a supply potential via the first current mirror; and
the buffer circuit coupling the base and collector of the third bipolar transistor with each other, couples the base of the third transistor with the second current mirror, the second current mirror coupling this buffer circuit with the node for applying the supply potential.

11. A bandgap circuit, comprising:
a first resistor configured to receive a voltage proportional to absolute temperature across its terminals;
a second resistor configured to receive a voltage complementary to absolute temperature across its terminals;
a third resistor, wherein a current flow through the third resistor is equal to a sum of a current flow through the first resistor and a current flow through the second resistor;
wherein the second resistor comprises, connected in series, a first fixed resistance part, a first controllable resistance part and a second controllable resistance part;
wherein the third resistor comprises, connected in series, a second fixed resistance part, a third controllable resistance part and a fourth controllable resistance part; and
a control circuit configured to generate:
a first trimming signal applied to the first and third controllable resistance parts; and
a second trimming signal applied to the second and fourth controllable resistance parts.

12. The bandgap circuit of claim 11, wherein each controllable resistance part is equal to a product of a set value of said controllable resistance part and an integer number set by the trimming signal.

13. The bandgap circuit of claim 12, wherein the set value for the first controllable resistance part is different than the set value for the third controllable resistance part.

14. The bandgap circuit of claim 12, wherein the set value for the second controllable resistance part is different than the set value for the fourth controllable resistance part.

15. The bandgap circuit of claim 12, wherein the set value of the third or fourth controllable part of the third resistor is equal to a Gain value times the set value of the associated first or second controllable part of the second resistor, respectively.

16. The bandgap circuit of claim 12, wherein the set value of the first or second controllable part of the second resistor is null.

17. The bandgap circuit according to claim 11, wherein the first and second fixed resistance parts of the second and third resistors have a same resistance value.

18. The bandgap circuit according to claim 11, wherein a resistance value of the second fixed resistance part of the second resistor is equal to a value times a resistance value of the first resistor.

19. The bandgap circuit according to claim 11, further comprising:
a first bipolar transistor;
a second bipolar transistor; and
a third bipolar transistor;
wherein bases of the first and second bipolar transistors are connected to each other and to a collector of the first bipolar transistor;
wherein the first resistor is coupled in series between an emitter of the second bipolar transistor and a node for applying a reference potential;
wherein the second resistor is connected between a base of the third bipolar transistor and the node for applying the reference potential.

20. The bandgap circuit according to claim 19, further comprising:
current mirroring circuitry coupled to the first, second and third bipolar transistors and configured to mirror current flow through the first and second resistors to a current summing node for generating the current flow through the third resistor.
